(19) United States
(12) Patent Application Publication
(10) Pub. No.: US 2024/0241580 A1
(43) Pub. Date: Jul. 18, 2024

(54) VIRTUAL REALITY PROPRICEPTION CONTROL SYSTEM AND METHOD

(71) Applicant: Osirius Group, LLC, Troy, MI (US)

(72) Inventors: Richard Matthew CIESZKOWSKI, III, Bloomfield Hills, MI (US); Timothy David SMITH, Bloomfield Hills, MI (US)

(21) Appl. No.: 18/414,966

(22) Filed: Jan. 17, 2024

Related U.S. Application Data
(60) Provisional application No. 63/439,315, filed on Jan. 17, 2023.

(51) Int. Cl. G06F 3/01; G06F 3/14; G06F 3/16

(52) U.S. Cl. CPC G06F 3/013; G06F 3/012; G06F 3/016; G06F 3/14; G06F 3/16

(57) ABSTRACT

A method for proprioception control includes receiving user information corresponding to a user wearing a head mounted device while interacting with a simulated environment. The method further includes determining, based on the user information, whether a proprioception of the user is impaired. The method further includes generating, based on the determination that the proprioception of the user is impaired, at least one proprioception aid. The method further includes providing, to the user using the head mounted device, the proprioception aid.

### CROSS-REFERENCE TO RELATED APPLICATIONS

This utility patent application claims the benefit of U.S. provisional patent application Ser. No. 63/439,315, filed on Jan. 17, 2023, the entire disclosure of which is hereby incorporated by reference in its entirety.

### TECHNICAL FIELD

This disclosure relates to virtual reality systems, and in particular, control of a user's proprioception during use of virtual reality systems.

### BACKGROUND

Computer-generated virtual reality (VR) systems provide a user with an interactive simulated environment, in which, the user can interact with objects, characters, and/or other aspects of the simulated environment. VR systems are used in a variety of applications, such as virtual gaming, virtual simulation, virtual training, virtual therapy, and the like.

### SUMMARY

This disclosure relates generally to proprioception control systems and methods.

An aspect of the disclosed embodiments is a method for proprioception control. The method includes receiving user information corresponding to a user wearing a head mounted device while interacting with a simulated environment. The method further includes determining, based on the user information, whether a proprioception of the user is impaired. The method further includes generating, based on the determination that the proprioception of the user is impaired, at least one proprioception aid. The method further includes providing, to the user using the head mounted device, the proprioception aid.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic illustration virtual reality system in accordance with an aspect of the disclosure.

FIG. 2 is a block diagram of a proprioception control system according to the principles of the present disclosure.

FIG. 3 is a flow diagram illustrating a proprioception control method according to the principles of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a computer-generated virtual reality (VR) system provides a user with an interactive simulated environment, in which, the user can interact with objects, characters, and/or other aspects of the simulated environment. The VR system may be used in a variety of applications, such as virtual gaming, virtual simulation, virtual training, virtual therapy, and the like. Typically, a user engages with the VR system using peripherals such as displays, virtual reality head mounted displays (HMD), speakers, joysticks, chairs, treadmills, cages, gloves, boots, body suits, and the like.

While engaging in a simulated environment (e.g., using a VR system and one or more of the peripherals, as described), a user may be presented with visual, audio, and haptic simulations that allow the user to experience the simulated environment. For example, a user may wear an HMD to see and hear the simulations associated with the virtual environment. While wearing such an HMD, the user may be able view the simulated environment in any direction. Additionally, or alternatively, the user may be able to traverse the simulated environment and interact with objects in simulated environment. For example, the user may be able to walk to an object in the simulated environment and pick up the object. In order to simulate the user interacting with the environment, the user may be presented, in the simulated environment, with virtual body parts, such as virtual hands and legs. Accordingly, when the user wants to reach for an object in the simulated environment, the user reaches, in the user's real environment, typically using a controller, which will cause the virtual hand to reach for the object in the simulated environment.

In some cases, users interacting with such simulated environment (e.g., using an HMD) may experience impairments in proprioception. The user's proprioception refers to the user's awareness of the position and movement of the user's body. Proprioception is provided by proprioceptors in the skeletal muscles, tendons, and fibrous membrane of the user's joint capsules. The user's brain receives information from the proprioceptors and combines the proprioceptor information with information from user's sensor system, such as the vision system, to provide the user with an unconscious proprioception of a relative position and movement of the user's body parts. Accordingly, while engaging in the simulated environment, the brain may receive information from the sensory system (e.g., the vision system) that does not accurately correspond to the information received from the proprioceptors (e.g., because the user is visually receiving information generated by the simulated environment which may not be completely accurate to the real environment aspects of the user). Such discrepancy in information may cause the user to become dizzy, disoriented, off-balance, nauseous, and the like.

Typically, in order to improve proprioception and/or stability of the user while engaging in the simulated environment, systems will include large-scale stability improvement devices, such as treadmills, a body ring, stability bars, and/or other suitable large-scape stability devices. However, such devices can be cumbersome to use, increase the cost of the VR system, and may restrict how a user can move in the real environment, while interacting in the simulated environment. Additionally, medical devices may be used to interact with the user's vestibular system in order to improve stability and/or proprioception while interacting with the simulated environment. The medical devices may be disposed on or near the user, such as on the user's head, on the user's neck, or intraorally disposed in the user's mouth, or implanted in the user's brain or nervous system. Such medical devices may be cost prohibitive, may require a medical professional to administer and/or maintain, may be invasive, and/or may restrict movement of the user in the real environment. Accordingly, systems and methods, such as those described herein, that include a proprioceptive device and that improve a user's stability and/or proprioception while engaging with a VR system while allowing the user to freely move in the real world, may be desirable. In some embodiments, as will be described, the proprioceptive device may be integrated into an HMD as a low-profile feature.

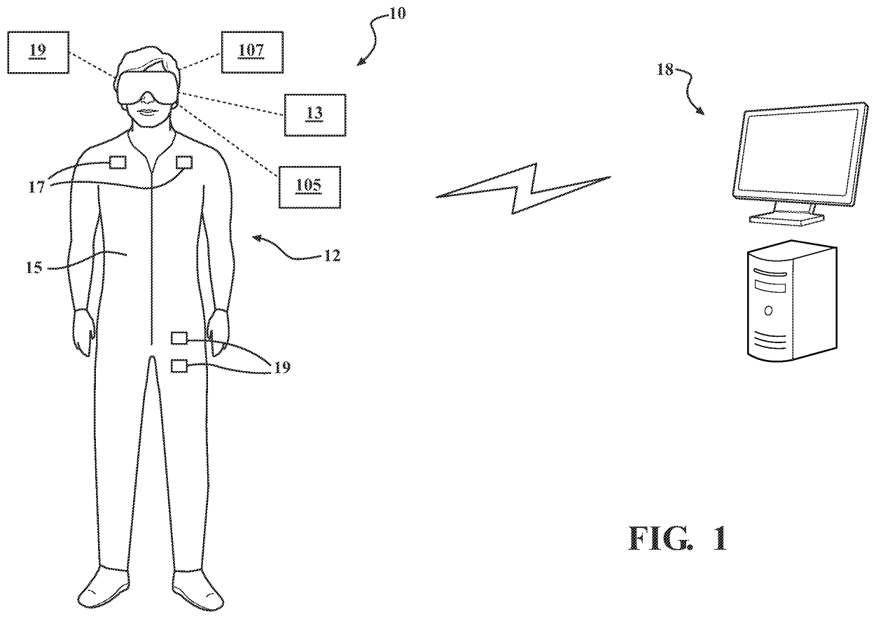

FIG. 1 generally illustrates a virtual reality system 10 according to the principles of the present disclosure. The system 10 includes a user 12, a head mounted device (HMD) 14, a motion capture device 16, and a computing device 18. The user 12 may wear the HMD 14 and the motion capture device 16. The HMD 14 may comprise a helmet, mask, goggle, glasses, shield, or other suitable device. The HMD 14 may comprise any suitable head mounted device and may include at least one screen disposed within the HMD 14. The screen of the HMD 14 may be configured to receive video associated with a simulated environment of the system 100. The video may be communicated to the HMD 14 by the computing device 18. Additionally, or alternatively, the HMD 14 may include one or more sound emitting device 19 such as headphones or speakers which may receive and play audio associated with the simulated environment from, for example, the computing device 18. The computing device 18 may comprise any suitable computing device, such as an application server, main server, client computer, mobile computing device, and the like. The computing device 18 includes, at least, a memory and a processor. The memory is configured to store instructions that, when executed by the processor cause the processor to execute the simulated environment. In some embodiments, the HMD 14 may omit sound from a sound emitting device 19. The user 12 may wear one or more sound emitting devices 19 (e.g., such as headphones and speakers) that may be configured to play audio associated with the simulated environment.

In some embodiments, the HMD 14 may provide haptic feedback to the user 12. For example, in response to a scenario in the simulated environment, a haptic actuator 13 of the HMD 14 may be actuated to provide the haptic feedback to the user 12. In some embodiments, the motion capture device 16 includes a suit 15, a shoulder strap, a back strap, and/or other suitable motion capture device. The motion capture device 16 may include a plurality of sensors 17 disposed throughout the motion capture device 16. The sensors 17 are adapted to detect motion of a region of the user 12 and communicate the detected motion to the motion capture device 16. The motion capture device 16 may then communicate the detected motions to the HMD 14 and/or the computing device 18. The detected motions may be processed by the HMD 14 and/or the computing device 18 and simulated motions of the user 12 in the simulated environment may be generated based on the detected motions. It should be understood that the system 10 may include additional or fewer components than those described herein. Additionally, or alternatively, the system 10 may comprise a multi-user system, such that, multiple users can interact with the simulated environment simultaneously. Further, the system 10 may communicate with remote computing devices, such as application servers, main servers, client computers, or other suitable computing devices.

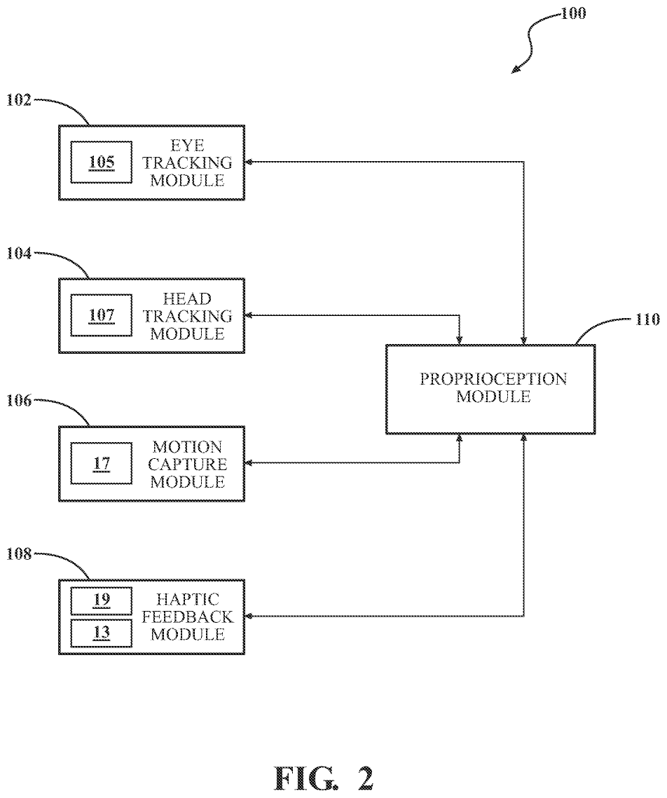

In some embodiments, the HMD 14 is configured to provide proprioceptive control to the user 12. For example, the HMD 14 may include a proprioception control system (PCS) 100, as is generally illustrated in FIG. 2. It should be understood that components of the PCS 100 may be integrated into the HMD 14 and/or disposed on the computing device 18. Additionally, or alternatively, the HMD 14 includes a memory and a processor. The memory is configured to store instructions that, when executed by the processor, cause the processor to execute the function of the PCS 100.

The PCS 100 includes an eye tracking module 102, a head tracking module 104, a motion capture module 106, a haptic feedback module 108, and a proprioception module 110. It should be understood that the PCS 100 may include additional or fewer components than those described herein. For example, while not illustrated, the PCS 100 may include and/or communicate with a plurality of sensors, actuators, and other modules than those described herein. The eye tracking module 102 may include and/or be in communication with one or more sensors 105 configured to detect movement of the user's eyes while the user wears the HMD 14. The one or more sensors 105 may include any suitable sensor or sensing device, including, but not limited to, position sensors, motion sensors, optical sensors, or other suitable sensors. The eye tracking module 102 may determine a position and/or motion of the user's eyes based on the movement detected by the one or more sensors 105. The eye tracking module 102 communicates the determined position and/or motion of the user's eyes to the proprioception module 110. The eye tracking module 102 may continuously monitor or track the position and/or movement of the user's eyes while the user wears the HMD 14 and may continuously communicate the position and/or movement of the user's eyes to the proprioception module 110.

The head tracking module 104 may include and/or be in communication with one or more head sensors 107 configured to detect movement or a position of the user's head while the user wears the HMD 14. The one or more head sensors 107 may include any suitable sensor or sensing device, including, but not limited to, position sensors, motion sensors, gyroscopic sensors, or other suitable sensors. The head tracking module 104 may determine a movement or a position of the user's head based on the motion detected by the one or more head sensors 107. The head tracking module 104 communicates the determined position and/or motion of the user's head to the proprioception module 110. The head tracking module 104 may continuously monitor or track the position and/or movement of the user's head while the user wears the HMD 14 and may continuously communicate the position and/or movement of the user's head to the proprioception module 110.

The motion capture module 106 may include and/or be in communication with one or more sensors 17 configured to detect motion of various portions of the user's body while the user wearing the motion capture device 16. The one or more sensors 17 may include any suitable sensors or sensing devices, including, but not limited to, position sensors, motion sensors, pressure sensors, or other suitable sensors. For example, the motion capture device 16 may be positioned on the user's body, such that, the one or more sensors 17 align with joints, muscles, or other aspects of the user's body while the user wears the motion capture device 16. As the user moves in the real environment (e.g., to cause the user's virtual body parts to move in the simulated environment), the one or more sensors 17 may detect actual positions and/or movements of the associates aspects of the user's body.

The motion capture module 106 may determine actual movement of the user's body parts corresponding to the aspects of the user's body monitored by the one or more sensors 17. For example, the motion capture module 106 may determine that a user's arm is in a first position based on one or more detected (e.g., by the one or more sensors 17) positions and/or movements of an elbow joint of the arm. The motion capture module 106 communicates the determined position and/or motion of the user's body and/or body parts to the proprioception module 110. The motion capture module 106 may continuously monitor or track the position and/or movement of the user's body and/or body parts while the user wears the motion capture device 16 and may continuously communicate the position and/or movement of the user's body and/or body parts to the proprioception module 110.

The haptic feedback module 108 may include and/or be in communication with one or more actuators 13, 119 configured to provide haptic feedback to the user while the user wears the HMD 14. For example, while the user wears the HMD 14 and interacts with the simulated environment, something in the simulated environment may touch the user's head. The haptic feedback module 108 may actuate the one or more actuators 13, 119 to provide haptic feedback to the user in the real environment, such that the user feels the touch of the simulated environment. The haptic feedback module 108 may communicate to the proprioception module 110 indicating which of the one or more actuators 13, 119 were actuated. Additionally, or alternatively, the haptic feedback module 108 may communicate to the proprioception module 110 an intensity or pressure associated with the actuation of the one or more actuators 119. The haptic feedback module 108 may continuously communicate to the proprioception module 110 aspects of the one or more actuators.

As described, the user may become dizzy, disoriented, off-balance, nauseous, and the like, while wearing the HMD 14 and interacting with the simulated environment. This may be due to proprioception impairment of the user. For example, as described the user may move an arm in the real environment in order to cause a virtual arm in the simulated environment to move. Such movement may not accurately correspond to the movement of the user's arm in the real environment. During prolonged interaction with the simulated environment, such inaccuracy may cause the user's brain to misinterpret or confuse a real positon of the user's body parts. For example, the user's brain may interpret the user's arm to be in a position that is different from an actual position of the user's arm. Accordingly, the proprioception module 110 is configured to monitor aspects of the user and the simulated environment and provide feedback to the user while the user wears the HMD 14 to correct the user's proprioception.

For example, as described the proprioception module 110 receives user information, such as eye tracking information, head tracking information, motion capture information, and haptic feedback information from the eye tracking module 102, the head tracking module 104, the motion capture module 106, and the haptic feedback module 108, respectively. The proprioception module 110 may receive additional information from various sensors, other modules, and/or the simulated environment while the user wears the HMD 14 and interacts with the simulated environment.

The proprioception module 110 determines, based on the user information, whether the user's proprioception is impaired, or may become impaired. For example, the proprioception module 110 may determine that the user's proprioception is likely to become impaired in response to a position of the user's eyes and a position of the user's head relative to an object in the simulated environment. While only limited examples are described, it is understood that the proprioception module 110 may determine whether the user's proprioception is impaired or may become impaired using any of the user information or other suitable information in any suitable combination.

When the proprioception module 110 determines the user's proprioception is impaired or may become impaired, the proprioception module 110 may generate one or more proprioception aids in order to repair or prevent impairment of the user's proprioception. While only proprioception aids are described herein, the proprioception module 110 may generate any suitable aid or corrective action in response to the determination that the user's proprioception is impaired or may become impaired. For example, the proprioception module 110 may generate a visual aid that, when presented to the user, reestablishes and/or helps correct the user's proprioception. The proprioception module 110 may communicate with the eye tracking module 102 and/or the screen of the HMD 14 to present the visual aid to the user.

In another example, the proprioception module 110 may generate an audio aid that, when presented to the user, reestablishes and/or helps correct the user's proprioception. The proprioception module 110 may communicate with the sound emitting device 19 worn by the user to play the audio aid to the user. In another example, the proprioception module 110 may generate a haptic aid that, when presented to the user, reestablishes and/or helps correct the user's proprioception. The proprioception module 110 may communicate with the haptic feedback module 108 or other suitable haptic feedback devices to provide the user with the haptic feedback.

In some embodiments, the proprioception module 110 is configured to provide any suitable combination of the aids described herein. In some embodiments, the proprioception module 110 is configured to receive feedback from the eye tracking module 102, the head tracking module 104, the motion capture module 106, the haptic feedback module 108, the user, or other suitable sources indicating the user's response to the aids provided by the proprioception module 110. The proprioception module 110 may generate additional aids, modify the aids, or provide other various information, aids, or feedback to the user in response to the feedback to the aids provided by the proprioception module 110.

In another example, the proprioception module 110 may be configured to train a user's brain to correct systemic proprioception (e.g., as the result of an injury, illness, age, and the like). The proprioception module 110 may provide visual aids, audio aids, haptic aids, or other suitable aids to the user to reestablish and/or help correct proprioception. The proprioception module 110 may receive feedback from the eye tracking module 102, the head tracking module 104, the motion capture module 106, the haptic feedback module 108, the user, or others indicating the user's response to the aids provided by the proprioception module 110. In another example, the proprioception module 110 may determine that the user's proprioception is impaired beyond a threshold and may provide a recommendation (e.g., visual and/or audio using the HMD 14 and/or headphones, as described) indicating to the user that the user should disengage from the simulated environment until the user's proprioception is reestablished and/or corrected.

In some embodiments, the proprioception module 110 may be configured to impair or disrupt the user's orientation, balance, or other aspects of the user's proprioception in response to information from the simulated environment. For example, the simulated environment may simulate an earthquake or other suitable balance distorting scenario. The proprioception module 110 may generate aids, such as those described herein, that disorient the user or disrupt the user's balance, such that, the user experiences a physical response to the simulated balance distorting scenario presented by the simulated environment. It should be understood that, while limited examples are provided, the proprioception module 110 may generate any suitable aids, feedback, information, and the like to reestablish and/or help correct the user's proprioception and/or to disrupt or impair the user's proprioception. In some embodiments, the proprioception module 110 is configured to continuously monitor the user information and continuously generate aids, as described, to reestablish, help correct, and/or disrupt the user's proprioception.

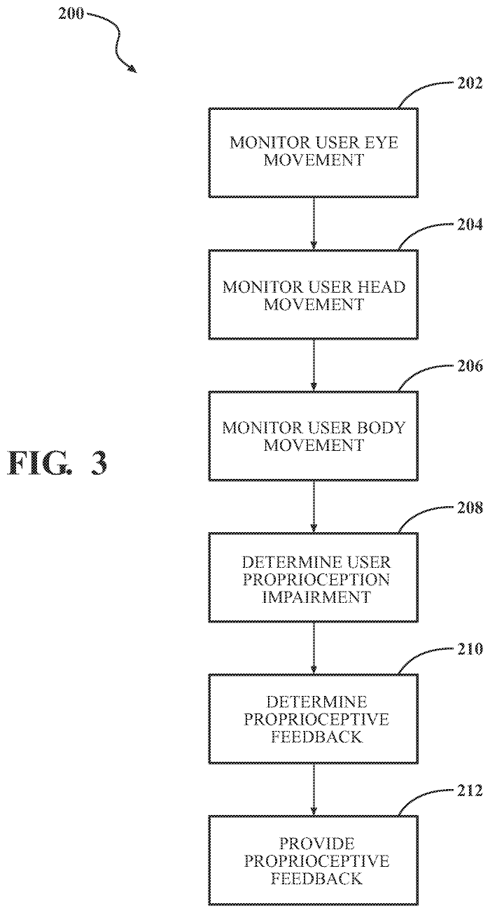

FIG. 3 a flow diagram illustrating a proprioception control method 200 according to the principles of the present disclosure. In some embodiments, the PCS 100 may perform the methods described herein. However, the methods described herein as performed by the PCS 100 are not meant to be limiting, and any type of software executed by a processor can perform the methods described herein without departing from the scope of this disclosure.

At 202, the method 200 monitors user eye movement. As described, the eye tracking module 102 may, using the one or more sensors 105, determine a position and/or movement of the user's eyes while the user wears the HMD 14 and interacts with the simulated environment. At 204, the method 200 monitors user head movement, such as via head sensors 107. As described, the head tracking module 104 may, using the one or more head sensors 107, determine a position and/or movement of the user's head while the user wears the HMD 14 and interacts with the simulated environment. At 206, the method 200 monitors user body movement. As described, the motion capture module 106 may, using the one or more sensors 17, determine a position and/or movement of the user's body and/or body parts while the user wears the motion capture device 16 and interacts with the simulated environment. At 208, the method 200 determines user proprioception impairment. As described, the proprioception module 110 uses, at least, the user information received from the eye tracking module 102, the head tracking module 104, the motion capture module 106, and the haptic feedback module 108, respectively, to determine whether the user's proprioception is impaired or may become impaired. At 210, the method 200 determines proprioceptive feedback. As described, the proprioception module 110 generates various aid, such as those described herein, that, when provided to the user, reestablishes, and/or helps correct the user's proprioception. At 212, the method 200 provides proprioceptive feedback. As described, the proprioception module 110 provides the generated aids to the user, as described. The proprioception module 110 may monitor feedback responsive to the airs provided by the proprioception module 110. The proprioception module 110 may generate additional aids, modify aids, generate other feedback and/or information and in response to the feedback.

In some embodiments, a method for proprioception control includes receiving user information corresponding to a user wearing an HMD 14 while interacting with a simulated environment. The method further includes determining, based on the user information, whether a proprioception of the user is impaired. The method further includes generating, based on the determination that the proprioception of the user is impaired, at least one proprioception aid. The method further includes providing, to the user using the HMS 14, the proprioception aid.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for proprioception control, the method comprising:
receiving user information corresponding to a user wearing a head mounted device while interacting with a simulated environment;
determining, based on the user information, whether a proprioception of the user is impaired;
generating, based on the determination that the proprioception of the user is impaired, at least one proprioception aid; and
providing, to the user using the head mounted device, the proprioception aid.

2. The method as set forth in claim 1, wherein the proprioception aid includes visual information presented to the user with a screen of the head mounted device.

3. The method as set forth in claim 1, wherein the proprioception aid includes audio information delivered to the user through a sound emitting device.

4. The method as set forth in claim 1, wherein the proprioception aid includes haptic feedback delivered to the user via a haptic feedback device.

5. The method as set forth in claim 1, wherein the proprioception aid includes visual information presented to the user with a screen of the head mounted device, audio information delivered to the user through a sound emitting device and haptic feedback delivered to the user via a haptic feedback device.

6. The method as set forth in claim 1, further including indicating to the user that the user should disengage from the simulated environment until the user's proprioception is reestablished.

7. The method as set forth in claim 6, wherein the indication to the user is transmitted through a screen of the head mounted device or a sound emitting device.

8. The method as set forth in claim 7, wherein the indication to the user is transmitted in response to a detection that the user's proprioception is impaired beyond a predetermined threshold.

9. The method as set forth in claim 1, wherein the user information received includes at least one of eye tracking information, head tracking information, motion capture information, and haptic feedback information.

10. The method as set forth in claim 9, wherein receiving eye tracking information includes determining a position of the user's with an eye tracking sensor.

11. The method as set forth in claim 9, wherein receiving head tracking information includes determining a position of the user's head with at least one head sensor.

12. A virtual reality system, comprising:
a head mounted device configured to present a simulated environment to a user;
at least one sensor configured to determine whether a proprioception of the user is impaired;
at least one output device configured to generate a proprioception aid to the user; and
a computing device configured to receive user information from the at least one sensor and to determine, based on the user information, whether a proprioception of the user is impaired, and to generate a proprioception aid to the user with the at least one output device.

13. The system as set forth in claim 12, wherein the at least one output device includes a screen of the head mounted device, and wherein the proprioception aid includes visual information presented to the user with the screen of the head mounted device.

14. The system as set forth in claim 12, wherein the at least one output device includes a sound emitting device, and wherein the proprioception aid includes audio information delivered to the user through the sound emitting device.

15. The system as set forth in claim 12, wherein the at least one output device includes a haptic feedback device, and wherein the proprioception aid includes haptic feedback delivered to the user through the haptic feedback device.

16. The system as set forth in claim 12, wherein the at least one output device includes a screen of the head mounted device, a sound emitting device and a haptic feedback device, and wherein the proprioception aid includes visual information presented to the user with a screen of the head mounted device, audio information delivered to the user through a sound emitting device and haptic feedback delivered to the user via a haptic feedback device.

17. The system as set forth in claim 12, wherein the computing device is further configured to instruct the at least one output device to indicate to the user that the user should disengage from the simulated environment until the user's proprioception is reestablished.

18. The system as set forth in claim 17, wherein the indication to the user is transmitted through a screen of the head mounted device or a sound emitting device.

19. The system as set forth in claim 12, wherein the user information includes at least one of eye tracking information, head tracking information, motion capture information, and haptic feedback information.

20. The system as set forth in claim 12, wherein the at least one sensor includes an eye tracking sensor configured to determine a position of the user's eye.
